(19) United States
(12) Patent Application Publication
(10) Pub. No.: US 2021/0237852 A1
(43) Pub. Date: Aug. 5, 2021

(54) AIRCRAFT

(71) Applicant: Dr. Ing. h.c. F. Porsche Aktiengesellschaft, Stuttgart (DE)

(72) Inventors: Mikel Fauri, Ludwigsburg (DE); Tim Schmidt, Freiberg am Neckar (DE)

(73) Assignee: Dr. Ing. h.c. F. Porsche Aktiengesellschaft, Stuttgart (DE)

(21) Appl. No.: 17/269,734

(22) PCT Filed: Aug. 2, 2019
(86) PCT No.: PCT/EP2019/025252

§ 371 Date: Feb. 19, 2021

(30) Foreign Application Priority Data
Aug. 20, 2018 (DE) 10 2018 120 200.8

(51) Int. Cl. B64C 11/00; B64D 27/24; H02K 7/14

(52) U.S. Cl. CPC B64C 11/001; H02K 7/14; B64D 27/24

(57) ABSTRACT

An aircraft has a ducted fan having a duct with an electrical machine integrated into it.

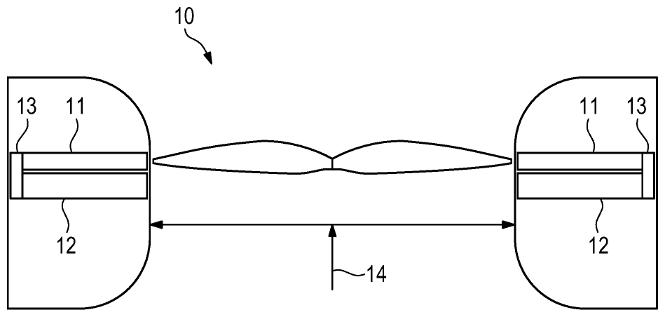

### FIELD OF THE INVENTION

The present invention relates to an aircraft, in particular a fully electric vertical take-off and landing, VTOL, aircraft.

### BACKGROUND OF THE INVENTION

Across different languages, in air and space travel technology VTOL designates any type of aircraft, drone or rocket which has the capability of lifting off and setting down again substantially vertically and without a take-off and landing runway. This collective term will be used below in a wide sense which includes not only fixed wing aircraft having aerofoils but likewise rotary wing aircraft such as helicopters, autogyros, gyrocopters and hybrids such as composite helicopters and convertiplanes are included. Also to be covered are aircraft having the capability of taking off and landing over particularly short distances (short take-off and landing, STOL), taking off over short distances but landing vertically (short take-off and vertical landing, STOVL) or taking off vertically but landing horizontally (vertical take off and horizontal landing, VTHL).

US2017/0274992A1 proposes a motor which comprises cylindrically stacked sub-motors with separate controls, in order to increase the reliability of the system.

CN 203655658 U discloses a forcible air cooling system for small electronic components.

CN 204858936 U deals with a magnetic transmission system for a fan from an axis offset to the side of the rotor arrangement.

### SUMMARY OF THE INVENTION

The invention provides an aircraft, in particular a fully electric aircraft capable of vertical take-off and landing in the sense defined above according to the independent claim 1.

One advantage of this solution lies in the inventive reduced shadowing of the active surface of the fan which, in conventional aircraft, follows from the central arrangement of the motor.

Embodiments of the invention in addition permit an increase in the efficiency and a higher level of integration of the fan duct.

Further advantageous refinements of the invention are specified in the dependent patent claims. Thus, the aircraft can be equipped, for example, with bent or even optionally bendable aerofoils. A corresponding variant enlarges the effective wing area in horizontal flight but without expanding the footprint of the aircraft.

Furthermore, the aircraft may have a quick-charge battery system which provides the drive energy for vertical take-off and landing and horizontal flight and permits short-notice charging of the aircraft while standing.

To drive the aircraft, instead of free-running rotors, multiple ducted fans, even of different size, can be used here, as are known away from aircraft technology, for example from air cushion vehicles or airboats. The cylindrical housing surrounding the propeller is able in such an embodiment to considerably reduce the thrust losses resulting from vortices at the blade tips. Suitable ducted fans are able to be implemented horizontally or vertically aligned, pivotable between the two positions, or, for aerodynamic reasons, to be covered by louvres in horizontal flight. In addition, the production of pure horizontal thrust by means of stationary ducted fans is conceivable.

Finally—in addition to preferably fully autonomous operation of the aircraft—given suitable qualification, granting maual control to a human pilot is also considered, which lends the greatest possible flexibility to the device according to the invention.

### BRIEF DESCRIPTION OF THE DRAWING FIGURES

An exemplary embodiment of the invention is illustrated in the drawing and will be described in more detail below.

The sole FIGURE shows a drawing of the principle of the invention.

### DETAILED DESCRIPTION OF THE INVENTION

The sole FIGURE illustrates the constructional features of a preferred configuration of the aircraft according to the invention. In each of its electrically driven fans (10), an electric machine (11, 12) is integrated into the outer ring within the duct. Both its rotor (11) and stator (12) are located outside the active region (14) of the associated ducted fan (10). As a result, its shadowing is avoided and the driving force is utilized completely. A guide rail or another axial bearing (13) maintains the air gap of the electric machine (11, 12).

For the ducted fan (10) a minimum structural support whilst tolerating negligible shadowing is considered, without departing from the scope of the invention.

1.-10. (canceled)

11. An aircraft comprising:
a ducted fan having a duct with an integrated electric machine including a rotor and a stator, wherein the ducted fan has an axial bearing in the form of a guide rail, and the axial bearing supports the rotor at a predefined distance from the stator,
wherein both the rotor and the stator are arranged outside of an active region of the ducted fan.

12. The aircraft as claimed in claim 11, further comprising a fully electric drive.

13. The aircraft as claimed in claim 11, further comprising bent or bendable aerofoils.

14. The aircraft as claimed in claim 11, further comprising a quick-charge battery system.

15. The aircraft as claimed in claim 11, further comprising horizontally stationary ducted fans for take-off and landing.

16. The aircraft as claimed in claim 15, further comprising louvers that are configured to selectively cover the horizontal ducted fans.

17. The aircraft as claimed in claim 11, further comprising vertically stationary ducted fans for producing forward drive.

18. The aircraft as claimed in claim 11, wherein the aircraft is fully autonomously controllable.
